(19) United States
(12) Patent Application Publication
(10) Pub. No.: US 2016/0043980 A1
(43) Pub. Date: Feb. 11, 2016

(54) METHOD AND SYSTEM OF VERIFYING THE AUTHENTICITY OF USERS IN AN ELECTRONIC MESSAGING SERVICE

(71) Applicant: StoryCloud, Inc., San Diego, CA (US)

(72) Inventors: Kenneth J. KALB, Solana Beach, CA (US); Michael W. Tracy, Solana Beach, CA (US); Barry Shapira, Solana Beach, CA (US)

(21) Appl. No.: 14/455,595

(22) Filed: Aug. 8, 2014

(51) Int. Cl. H04L 12/58; G06Q 20/08

(52) U.S. Cl. CPC H04L 51/20; G06Q 20/08

(57) ABSTRACT

Various aspects of the disclosure describe a method and system for receiving an electronic communication from an account associated with a physical address. The method and apparatus provides a dynamic link to the electronic communication that is accessible to at least one recipient.

### BACKGROUND

1. Field

The present disclosure relates generally to an electronic messaging service and more specifically, an electronic messaging service that verifies the authenticity of users by verifying the validity of the users' physical address

2. Background

Electronic mail (email) has become a pervasive method of communication for many computer users worldwide. Since email provides a quick and easy method of communication that was not previously possible, email is now commonly used in the home and in the workplace to send all types of communications ranging from trivial notes to highly sensitive business communications. However, although conventional email systems are fast and convenient, these systems can be unreliable and untrustworthy due to limitations on security.

For instance, email scams continue to rise and flood numerous email accounts on a daily basis. Such scams take advantage of and victimize less savvy conventional email account holders. Although conventional email systems do provide some security mechanisms to try to assist in preventing future scams, not all nefarious emails are caught. When nefarious emails make it past conventional email security, it can be difficult to differentiate the reputable emails from the scams. Thus, either the email account holder may fall victim to another scam, or an email from a reputable sender will go unread. It is therefore difficult to provide an electronic messaging system that provides accountability and is difficult for scam artists to use.

### SUMMARY

Some aspects of the disclosure provide a mechanism for verifying the authenticity of a user attempting to create an account by verifying the authenticity of a physical address associated with a user. For instance, the authenticity of a physical address may be verified by sending a mailer with a passcode to the provided physical address. If the physical address is correct and corresponds to a physical location accessible to the user, then the user may provide the passcode to an electronic message service. The electronic message service may then verify the user and the physical address as authentic.

Some aspects of the disclosure provide a mechanism for verifying the authenticity of a user attempting to create an account by verifying the authenticity of a separate account associated with the user. In one embodiment, this other account may be a social media associated account in a private social network that is authenticated by an overall provider of the private social networks. In this manner, authenticity and accountability of the user may be provided.

The ability to associate a user with a physical address provides an added level of trust and accountability at the electronic message service. For instance, advertising messages are more likely to be taken seriously and less likely to be categorized as spam. Thus, the electronic message service also provides advertising users with the ability to target specific users of the electronic message service based on captured analytical data. The advertising users may send advertising messages to recipients along with a payment to entice the recipients to access the electronic message.

Some aspects of the electronic message service provide messages to recipients as a dynamic link so that if the sender decides to delete or cancel the message, the electronic message may be deleted from the electronic message service such that no recipient will be able to view the electronic message. The electronic message could be deleted after a recipient has already accessed the message such that the recipient will no longer be able to re-access the electronic message.

It is understood that other aspects of processes and apparatuses will become readily apparent to those skilled in the art from the following detailed description, wherein various aspects of apparatuses and methods are shown and described by way of illustration. As understood by one of ordinary skill in the art, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of apparatuses will now be presented in the detailed description by way of example, and not by way of limitation, with reference to the accompanying drawings, wherein:

FIG. 1 illustrates an exemplary network architecture of one aspect of the electronic message service.

FIG. 2 illustrates an exemplary flow of data during registration of an account on the electronic message service.

FIG. 3 illustrates an exemplary display window for creating an account on the electronic message service.

FIG. 4 conceptually illustrates a process for creating an electronic message account by associating the account with a physical address.

FIG. 5 illustrates an exemplary data flow for providing an electronic message from a sender to a recipient using an electronic message server.

FIG. 6 illustrates an exemplary display for accessing an electronic message provided by a registered user of the electronic message service.

FIG. 7 conceptually illustrates a process for providing an electronic message to a recipient using the electronic message service.

FIG. 8 conceptually illustrates a process for providing advertising messages to recipients on the electronic message service.

FIG. 9 conceptually illustrates a system architecture for an electronic message service.

FIG. 10 illustrates an exemplary computer system that may implement the electronic message service server.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The word “exemplary” is used herein to mean serving as an example, instance, or illustration. Any embodiment described herein as “exemplary” is not necessarily to be construed as preferred or advantageous over other embodiments. Likewise, the term “aspect” of an apparatus, method or article of manufacture does not require that all embodiments of the invention include the described components, structure, features, functionality, processes, advantages, benefits, or modes of operation.

Some aspects of the disclosure provide various processes and apparatuses for distributing electronic messages between reliable senders and receivers in an electronic message service. The electronic message service only registers accounts that are linked to a physical address so that users of the electronic message service can trust that they are receiving messages from real people or valid businesses. The electronic message service also provides a monetization model that entices users to access advertising messages by paying the users to view the advertising messages. Additionally, the electronic message service provides advertising users with features that assist the advertising user in creating targeted marketing campaigns

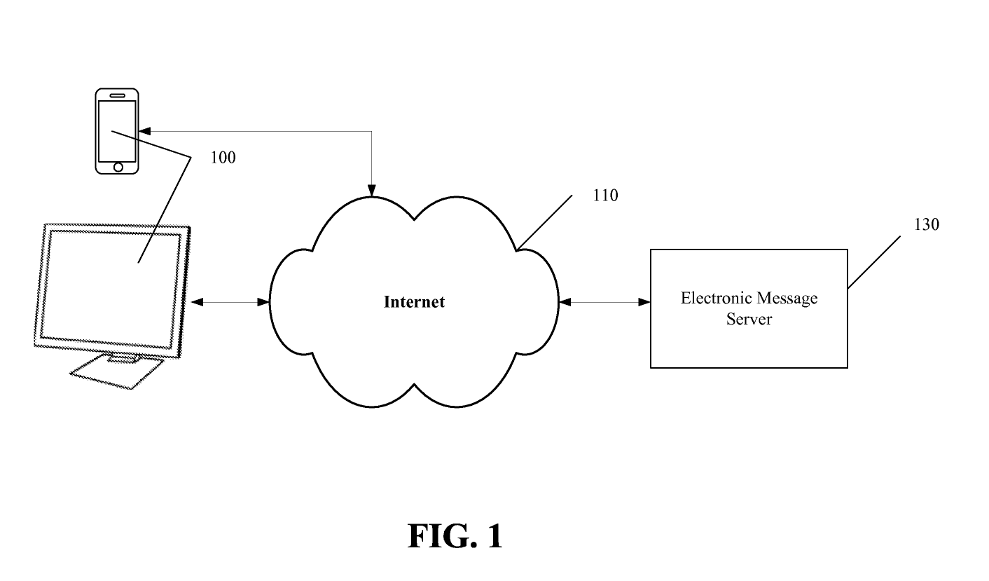

FIG. 1 illustrates an exemplary network architecture of one aspect of the electronic message service. The network architecture includes a client device 100, an internet service 110, and an electronic message server 130. The client device 100 communicates over a network interface with the internet 100. In some aspects of the electronic message service, the client device 100 may be a personal computer (e.g., desktop or laptop), a tablet, personal data assistant (PDA), a Smartphone, or any other device capable of accessing the internet. The client device 100 may use an internet service provider to access the internet through the network interface. The client device 100 may communicate with the electronic message server 130 over the internet 110. The electronic message server 130 may also communicate with the client device over the internet 110.

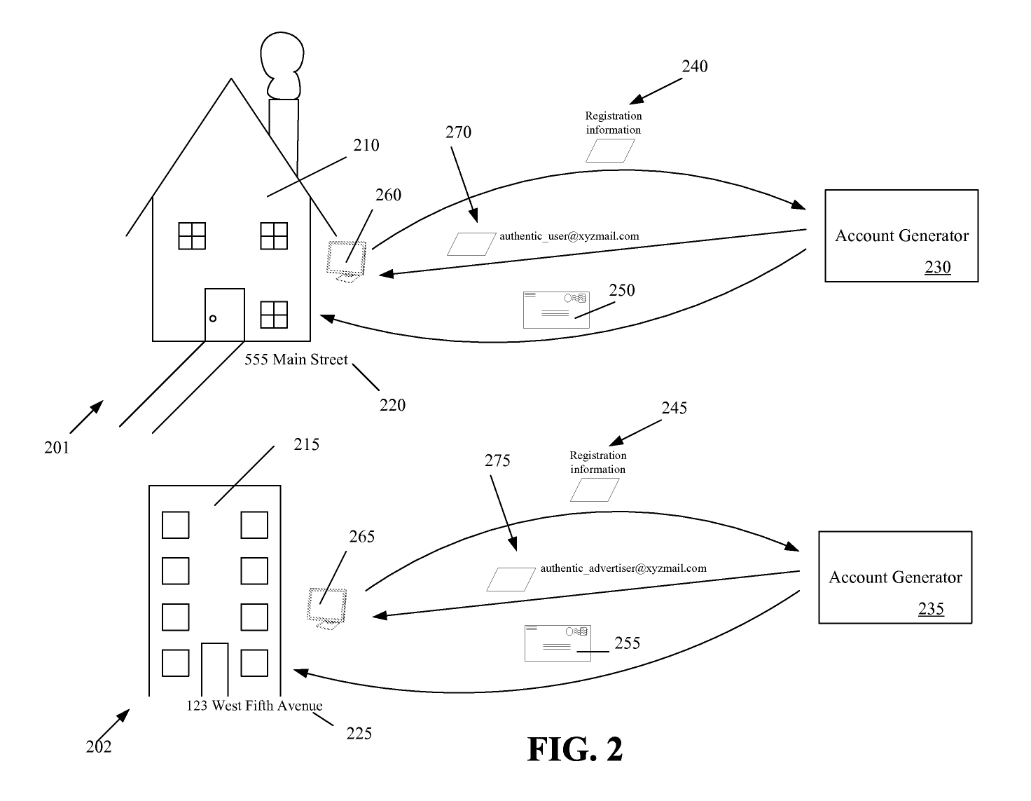

FIG. 2 illustrates an exemplary flow of data during registration of an account on the electronic message service. FIG. 2 illustrates the flow of data for a user creating a regular account 201 and the flow of data for a user creating an advertising account 202.

As shown, to create a regular user account, a user may create an account associated with an address 220 of a physical location 210. In this example, the physical location may be a home having one or more residents. Although only one account can be linked to a physical address, multiple email addresses may be created as part of the electronic message service. For instance, a master account may be created with several different email addresses that are all tied to different members of the household and controlled by permissions set in the master account. Conversely, only one email address may be associated with the physical address much like a physical postal mailbox.

Registration information 240 may be transmitted from a client device 260. It is not necessary for the client device to be located at the physical location 210. However, a physical location is required to register a new account. The physical address is included in registration information 240. Upon receipt of the registration information, the account generator 230 may generate and transmit a passcode 250 to the client device 260 by email, to an email address that is not linked to the electronic message service. Alternatively, the account generator may request that postal mail with the passcode 250 be generated and physically mailed to the physical location 210 designated by the address 220. The client device may then transmit the passcode information to the account generator. Once the passcode information is verified and accepted, a new account is created and a notification 270 is transmitted to the client device.

Creating an advertising account produces a similar data flow 202 to the data flow 201 for creating a regular account. As shown, registration information 245 that includes the address 225 of a physical location 215 may be transmitted by a client device 265. The registration information may be received at the account generator 235. In one aspect of the electronic message service, the registration information 245 may include a designation that this account is being created for a business user that wishes to provide targeted advertising content to other users of the electronic message service. Once the registration information 245 is received at the account generator 235, the account generator may generate a passcode and transmit it either by email or by postal mail to the address 225, which may have been supplied in the registration information 245. Upon receiving the passcode from the client device 265 and verifying that the passcode is correct, the account generator 235 may create a new advertising account and send a notification 275 to the client device 265 that the account has been created. Although only one client device is illustrated in each of the data flows 201 and 202, it is possible that account generators 230 and 235 may receive registration information from one client device and the passocode information from a different client device capable of communicating over the internet. Additionally, the notifications 270 and 275 may be received at any client device capable of communicating over the internet.

FIG. 3 illustrates an exemplary display window 300 for creating an account on the electronic message service. The display 300 may display on a client device communicatively connected to the electronic message service. The display window 300 includes display regions 310 and 330, and user interface (UI) objects 320. The UI objects of some aspects of the electronic message service may include text boxes, radio buttons, check boxes, buttons, or any user interface object capable of performing an action according to user interaction with the object.

Several selectable UI objects that are typically associated with web browsers and provide different web browsing functionalities are displayed in display region 310. Display region 330 includes the UI objects 320. UI objects 320 collect information from a user in order to create a user account. Some of the collected information may be required (e.g., an account will not be created until the information is provided) and other information may be optionally provided by the user and collected by the electronic message service. For instance, UI objects 320 include text boxes for receiving a user's legal name and physical address. The physical address may be required information since it is necessary to associate a user account with a physical address. Additionally, the association and account creation process may include verifying the address by either sending a generated code to the physical address, or by verifying the physical address with a database of known good addresses.

UI objects 320 may also receive demographic information such as the gender of the user, the user's age, occupation and other preferences. Such demographic information may be utilized by the electronic message service to provide analytical data to advertisers on the electronic message service or any user that may wish to pay a fee to collect such information. In some aspects of the electronic message service, the demographic information may be optionally received. Additionally, some aspects of the electronic mail service may request demographic information in a different window that is not associated with the account creation. In such aspects, the demographic information may be collected after the account has been created and the electronic message service has received user input to enter demographic information so that he/she can begin receiving targeted mailings. As will be discussed in detail in the foregoing paragraphs, some aspects of the electronic message service may entice users to provide such information because they will be rewarded with payment for accessing and/or viewing the targeted ads. In such aspects, the user will be paid in any currency including both physical and/or virtual currency.

FIG. 4 conceptually illustrates a process 400 for creating an electronic message account by associating the account with a physical address. The process 400 may be performed, for example, by the electronic message server 130. The process 400 may begin after a user has accessed the electronic message service through a web browser.

As shown, the process 400 receives (at 405) input of user information including a physical address and optionally, demographic information. The physical address may be the address of a place of residence or a business. The physical address is associated with the electronic message service, which provides an additional level of accountability to users of the electronic message service. For instance, only users with verified physical addresses would be permitted to use the electronic message system. Thus, users of the service are provided with additional comfort because odds are that other users of the service are legitimate users rather than fake or illegitimate users engaging in nefarious activities.

The process 400 generates (at 410) an authentication code or pin. The authentication code is generated for security purposes and to verify that the address provided by the user is valid. The process 400 provides (at 415) the authentication code to the user. The authentication code may be provided in a number of different ways. For instance, the authentication code may be mailed to the user at the physical address specified previously. Additionally, the electronic message service may have the capability of verifying that an address is valid and associated with the user through a public record database. In such instances, there may be no need to mail the authentication code, so the authentication code is provided by email or short message service (SMS) to the user's mobile device.

Once the authentication code has been provided to the user, the process 400 receives (at 420) user input of the provided authentication code. The user may provide the authentication code by accessing a website related to the electronic message service and providing the code for processing by the service. The service may automatically know the account and physical address associated with the activation code. Or, in some instances, the user may be required to log back into the electronic message service, where the electronic message service can then receive the user input of the provided authentication code. Once the authentication code has been received and verified, the process 400 creates (at 425) a new account and/or email account programmatically linked to the physical address. The process then ends.

Since the process 400 links the electronic message account to a physical address, some aspects of the electronic message service may provide an account for multiple members of the household. The members of the household may share one mailbox, or the members of the household may each have their own mailbox, on the same account. Additionally, a master account may be associated with the physical address. The master account may be able to set permissions for all other accounts sharing the same physical address. Additionally, electronic messages that are sent to the registered account may first be received only by the master account. The master account may then grant permission for other accounts tied to the same address to access the electronic message.

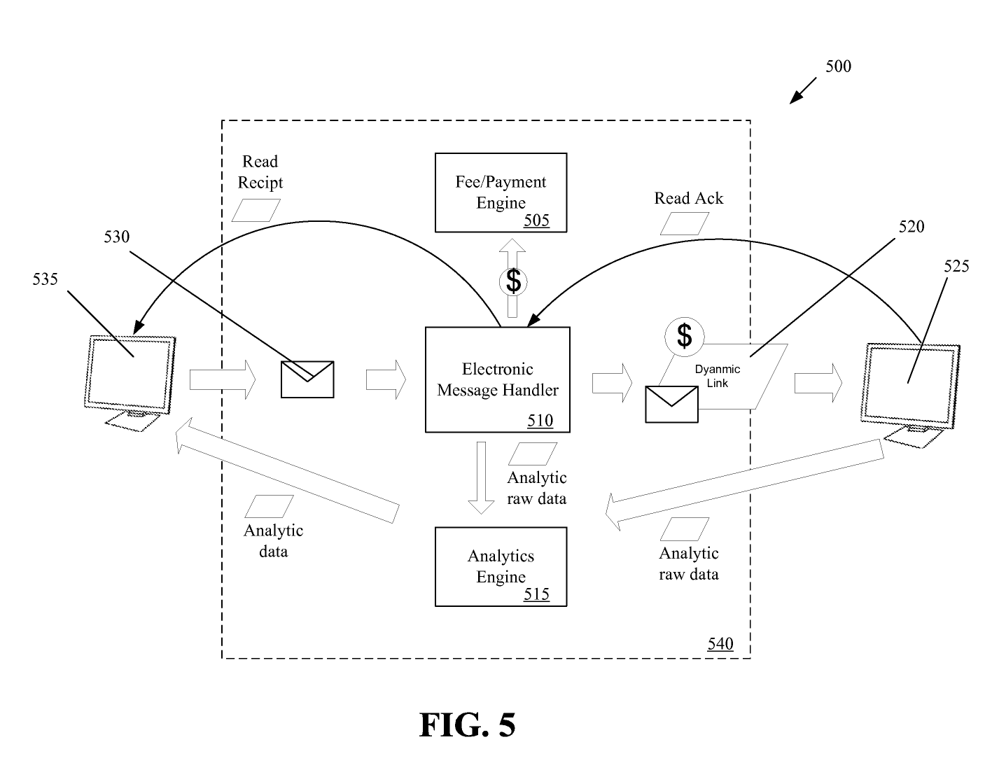

FIG. 5 illustrates an exemplary data flow 500 for providing an electronic message from a sender to a recipient using an electronic message server 540. As shown, the data flow 500 include client devices 525 and 535, a transmitted electronic message 530, a received electronic message 520, a fee/payment engine 505, an email handler 510, and an analytics engine 515.

As shown, the client device 535 transmits an electronic message 530, which is received at the electronic message server 540 by the email handler 510. The electronic message may be received by user input of a text or other audio/visual content to be provided to a recipient. The email handler determines if the message includes advertising content. If the message includes advertising content, the email handler notifies the fee/payment engine 505 that the electronic message is associated with a fee. The fee/payment engine 505 collects a portion of the payment. The other portion of the payment is held for the recipient, such that when the recipient accesses the electronic message, he/she may receive the other portion of the payment. In some aspects of the electronic message system, the electronic message server 545 collects half of the payment associated with the advertising message and the other half of the payment is provided to the recipient. Additionally, the email handler may provide analytical data associated with the message that was just received to the analytics engine 515. Such analytical information may include the number of recipients designated by the electronic message, where the electronic message was transmitted from, etc.

If the recipient designated by the electronic message service has an account with the electronic message service, then the email handler 510 transmits the electronic message 520 by dynamic link to the client device 525. However, if the recipient does not already have an account with the electronic message service, the email handler may store the message in a storage and generate an email to the recipient inviting him/her to create an account with the electronic message service (not shown). The electronic message server may hold the electronic message in storage until the recipient creates an account or until a predefined time period elapses.

The recipient of the electronic message 520 may be logged into the electronic message service from the client device 525. As shown, the electronic message 520 includes a dynamic link for accessing the message without permanently downloading the contents of the message onto the client device 525 and payment information. The electronic message is provided as a dynamic link so that if the sender decides to delete the message, he/she may do so without leaving additional copies on the electronic mail server 545 or any client devices. Thus, in this aspect of the electronic message service, the electronic message is only stored in a single location on the electronic message server.

Once the message has been accessed at the client device 525 a read acknowledgement is provided to the electronic message handler 510. The electronic message handler 510 may provide a read receipt to the original sender of the electronic message. The read recipt may be received at client device 535. Additionally, once the email handler receives the read acknowledgement, the electronic message handler may notify the fee/payment engine that the recipient has accessed the message and the other portion of the payment may be added to the recipient's account. The fee/payment engine may add the other portion of the payment to the recipients account.

Additionally, raw analytical data may be received at the analytics engine 515 from the client device 525. Such analytical data may include any information associated with the behavior of a user accessing the electronic message at client device 525. For instance, such raw analytical data may include read times, number of times read, and the location to which the electronic message was read. Cursor movement while the message was accessed, time between when the message was delivered and accessed, as well as other informative data. The analytics engine 515 processes the analytic raw data. The analytics engine 515 may process the raw data to provide useful reports to advertisers to aid in their targeted marketing. Thus, analytical data may be transmitted from the electronic message server 545 to the client device 535.

FIG. 6 illustrates an exemplary display 600 for accessing an electronic message provided by a registered user of the electronic message service. FIG. 6 illustrations two stages 601 and 602 of a user's interaction with the display 600. The display 600 may be displayed after the electronic message service has received login information from a user to log into a registered account on the electronic message service.

As shown, the first state 601 includes a display similar to the one described with respect to FIG. 3. However, display area 610 of display 600 also includes login information 630, message 620, and sender status notification 635. The login information 630 may include a recipient's account name or username. The message 620 may be an advertising message. The recipient may be tempted to view the advertising message if payment may be involved. The recipient is further provided with security in knowing that the sender is registered and verified by the electronic message service. The sender status notification 635 indicates to the recipient that the sender is verified by the electronic message service. Such verification includes requiring that the sender create an account verified with an actual physical address and verifying that the physical address exists.

The second stage 602 illustrates the display 600 after the user has selected the message 620. Selection of the message 620 may cause the electronic message service to provide a dynamic link for the electronic message to the device on which display 600 is displayed on. Additionally, information 650 about the electronic message may be displayed such as the sender's email address and the subject of the electronic message. In some aspects of the electronic message service, the electronic message may include multimedia content. For instance, in this example, a frame representing a video 640 is displayed in display area 610. Receiving a selection at UI object 645 may play a video of advertising content.

In some aspects of the electronic message service, the recipient may receive payment for viewing the advertising message. In such aspects of the electronic message service, the payment may be completed after the recipient opens the electronic message. Conversely, in such aspects of the electronic message service, the recipient may receive payment after a selection of UI object 645 is received and playback of the video 640 is started or completed. Providing recipients with the sender status notification 635 creates trust in the electronic message service environment because users that have a verified physical address are less likely to be involved in activities designed to scam other users. Thus, recipients can be assured that if the advertising message includes links, those links are more likely than not to lead to trusted internet websites, rather than websites that are designed with the malicious intent of stealing a user's personal information (e.g., account passwords, social security number, etc).

FIG. 7 conceptually illustrates a process 700 for providing an electronic message to a recipient using the electronic message service. The process 700 may be performed by the electronic message server 130. The process 700 may begin after a user has logged into the electronic message service.

As shown, the process 700 receives (at 705) an electronic message with optional content attached from the electronic message service user interface. In some aspects of the electronic message service, the content may be an attachment such as a document, a photograph, or a multimedia file. The process 700 verifies (at 710) whether the designated recipient of the electronic message is a user of the electronic message service. The electronic message service may verify the recipient's email address by checking a database of users to see if the recipient's email address exists in the database. The process 700 determines (at 715) whether the designated recipient has an account with the electronic message service. When the process 700 determines that the designated recipient does not have an account with the electronic message service, the process 700 stores (at 720) the electronic message in a waiting space and transmits a message to the recipient's email address to create an account with the electronic message service. When the process 700 determines (at 715) that the designated recipient does have an account with the electronic message service, the process 700 stores (at 725) the electronic message in the recipient's mailbox and provides the recipient with a dynamic link to the electronic message.

In some aspects of the electronic message service, the recipient may receive a dynamic link at his regular email account, which when selected, accesses the electronic message on the electronic message service. In other aspects of the electronic message service, the recipient may need to log onto the electronic message account using his login credentials, where he/she can see that a new message is waiting. The electronic message service may then provide the user with a link to access and view the electronic message.

Providing dynamic links to the electronic messages provides the extra benefit of added security to the sender. For instance, if the sender wishes to retract his message at anytime, the link could be broken by the electronic message service. So even if the recipient has already viewed the electronic message, all future attempts to access the message would fail.

Once the electronic message has been stored, the process 700 receives (at 730) raw analytics relating to the electronic message. The electronic message system may maintain analytic data (either data for individual users or aggregate data for groups) associated with all of the users of the electronic message service. Such data may be utilized by businesses interested in providing targeted ads to users that are most likely to use the service that the advertiser or business provides. Such analytics may involve capturing keywords or phrases in sent or received electronic messages, monitoring read times, and time to access the message. Other analytics may include the frequency that a particular user sends messages to another particular user or information about a user's frequent contacts. Such analytical data may be processed and provided to certain users of the electronic message service. Such users may be charged a higher fee than other users of the electronic message service. Or such users may be charged based on the number of advertisements that are distributed over the electronic message service.

FIG. 8 conceptually illustrates a process 800 for providing monetized messages (or advertisements) to recipients on the electronic message service. The process 800 may be performed by an electronic message server 130. The process 800 may begin after a user has logged into the electronic service. In some aspects of the electronic service, the user, in this case, has a special account that is linked to a financial account that is preloaded with money. In some aspects, the account may be reloaded with money by either providing credit card information or by linking to a bank account.

As shown, the process 800 receives (at 805) an electronic message from an advertising user that is to be sent to recipients who fit a specific criteria based on analytical data and demographic information. In some aspects of the electronic message service, analytical data is maintained for every user of the service. Additionally, the electronic message service may maintain demographic information either provided by the user during the account creation process or as generated from the analytical data.

At 810, the process 800 receives payment account information. For instance, the process 800 receives the information to access the preloaded account and to withdraw a specified amount of money from the account for payment to the recipients and the electronic message service. The process 800 processes (at 815) a portion of the payment. In some aspects of the electronic message service, the process 800 processes half of the payment that was withdrawn from the financial account. However, any predetermined portion of the payment may be taken for processing by the electronic message service.

The process 800 provides (at 820) the electronic message to a designated recipient as a dynamic link to the electronic message. In some aspects of the electronic message service, the process 800 provides the dynamic link so that if the sending user decides to retract the electronic message, he may do so at any time, including after the recipient has viewed the electronic message. The process 800 determines (at 825) whether a read receipt has been received from a particular user. The read receipt may be generated after a recipient has accessed and/or viewed the electronic message through the electronic link. The read receipt may be provided to the sending user as proof that the recipient viewed the message.

When the process 800 determines that the electronic message service has not received a read receipt, the process 800 does not deposit (at 830) any portion of the payment in the recipient's financial account. After a predetermined period of time, the electronic message service may return the undeposited portion of the payment to the sender's financial account and retract the electronic message. When the process 800 determines that the electronic message service has received a read receipt, the process 800 deposits (at 835) a portion of the of the payment in the recipient's account. Thus, the electronic message service encourages users to access and view advertising content because the recipients are financially compensated for their time. Once the process 800 either deposits the payment portion, or does not deposit the payment portion, the process 800 receives (at 840) raw analytic data from the recipient. Such analytic data may include, but is not limited to, read time, time to read, where the message was read, and how many times it was read. The process then completes.

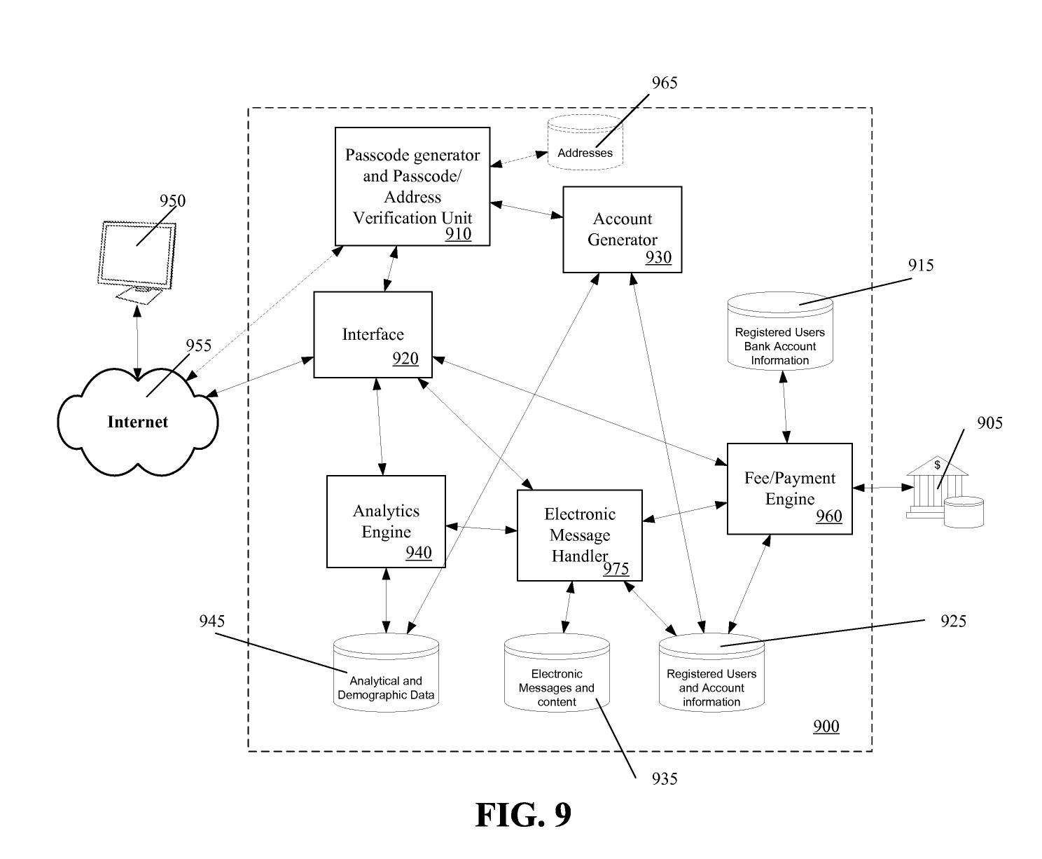

FIG. 9 conceptually illustrates a system architecture for an electronic message service. As shown, the system includes a server 900. In some aspects of the electronic message service, the server 900 may be the electronic message server 130 described with respect to FIG. 1. The electronic message server includes an interface 920, a passcode generator and passcode/address verification unit, account generator 930, Analytics engine 940, electronic message handler 975, fee/payment engine 960, analytical and demographics data storage 945, electronic messages and content storage 935, registered users and account information storage 925, registered users and bank account information storage 915, and optional addresses storage 965.

The electronic message server 900 communicates with a client device 950 over the internet 955. The electronic message server 900 also communicates with an external banking service through the fee/payment engine 960.

The interface 920 communicates information from the various modules of server 900 to the client device 950. In some aspects of the electronic message server, the interface may include a web server application. Such servers may include hypertext transfer protocol (HTTP) servers such as apache servers, internet information services (IIS), or another other suitable web server capable of understanding HTTP data.

The passcode generator and passcode/address verification unit 910 performs two functions. First, the pasccode generator and passcode/address verification unit 910 generates a passcode for a user that is attempted to create an account with the electronic message service. The passcode generator and passcode/address verification unit 910 may provide the passcode in an email for receipt on the client device 910. The passcode generator and passcode/address verification unit may optionally verify that the physical address provided during the registration process is a valid physical address by comparing it with addresses contained in the database 965. Alternatively, the passcode generator and passcode/address verification unit 910 may transmit instructions to another device to print a postal mailer (such as a postcard) that includes the passcode. The mailer may be sent to the physical address that is provided during the initial registration process. Once the mailer is received at the physical address, client device 950 may log back into the electronic message service and supply the mailed passcode to complete the registration process.

Second, the passcode may be verified by the passcode generator and passocode/address verification unit. If the passcode is invalid (e.g., the received passcode does not match a passcode associated with the account), the passocde generator and passcode/address verification unit 910 may transmit a message to the interface to send a notification to the client device 950 that the passcode is invalid. However, if the passcode is valid, the passcode generator and passcode/address verification unit 910 may send a message to the interface to send a message to the client device that registration was successful. The passcode generator and passcode/address verification unit 910 may also transmit a message to the account generator 930 to generate the account with the electronic message service based on the information received from the user during the account generation process.

For instance, the account generator 930 may store any demographic information acquired during the registration process in the analytical and demographic data storage 945. Additionally, analytical data may have been captured during the registration process. Such analytical data may also be stored by the account generator 930 in the analytical and demographic data storage 945. Once the account has been generated, the electronic message service may receive login information from the user to login and use the service.

The analytics engine 940 stores and retrieves analytical data for use in the electronic message service. For instance, the analytics engine may capture and store information such as read times of electronic messages, opens, where electronic messages are read. The analytics engine may perform different analyses of the analytical and demographic data that are useful to advertisers that use the electronic message service. Such analyses may be provided to the interface to provide to the client device 950.

The electronic message handler 975 is responsible for the electronic message communications between users of the electronic message service. The electronic message handler 975 may provide a dynamic link to the interface for providing to the client device 950, which accesses the contents of the electronic message. Electronic messages and any attachments (or contents) may be stored and retrieved by the electronic message handler 950. For instance, when the client device 950 transmits an electronic message using the electronic message service, the electronic message may be provided by the interface 920 to the electronic message handler 975. The electronic message handler 975 stores the message in the electronic messages and contents storage 935. When recipients of the electronic message wish to access the message, the electronic message handler 975 may retrieve the electronic message from the electronic message and contents storage 935 and provide temporary access to the content to the client device 950. The client device may receive the content through the interface 920 as a dynamic link.

The electronic message handler 975 also provides information to the analytics engine based on how the electronic messages were handled at the client device. For instance, the electronic message handler may provide information about when an electronic message was accessed, where it was accessed, and how long it was accessed for. The electronic message handler 975 may provide this information to the analytics engine for processing. Additionally, as discussed above, certain electronic messages may be associated with a payment or fee. Thus, if such a message is accessed, the electronic message handler may notify the fee/payment engine 960. The fee/payment engine 960 may determine whether a user should be paid for accessing a particular electronic message. If the fee/payment engine 960 determines that the user should be receive a payment, the fee/payment engine may update a user's account with the payment information in the registered users and account information storage 925. For instance, if a recipient viewed an advertisement message associated with a payment of $2, the recipient's financial account on the electronic message server 900 would be upped $2, while the sender's account would lose $2.

Additionally, it is possible to transfer money from the electronic message server to a banking institution. Such a transfer may take place by communicated with a banking server using an API. The fee/payment engine may use information about a user's personal banking account, such as account and routing numbers, to deposit the funds in the user's personal banking account. The personal banking information may be stored in the registered users bank account information storage 915. The information may be retrieved by the fee/payment engine 960 and used to deposit the appropriate funds according to account information retrieved from registered users and account information storage 925.

The modules of the electronic message server 900 provide a mechanism for targeting certain users based on information provided by the analytics engine and for enticing users to view advertising messages by paying users. Thus, advertisers can gain better traction by using the functions provided by the electronic message service.

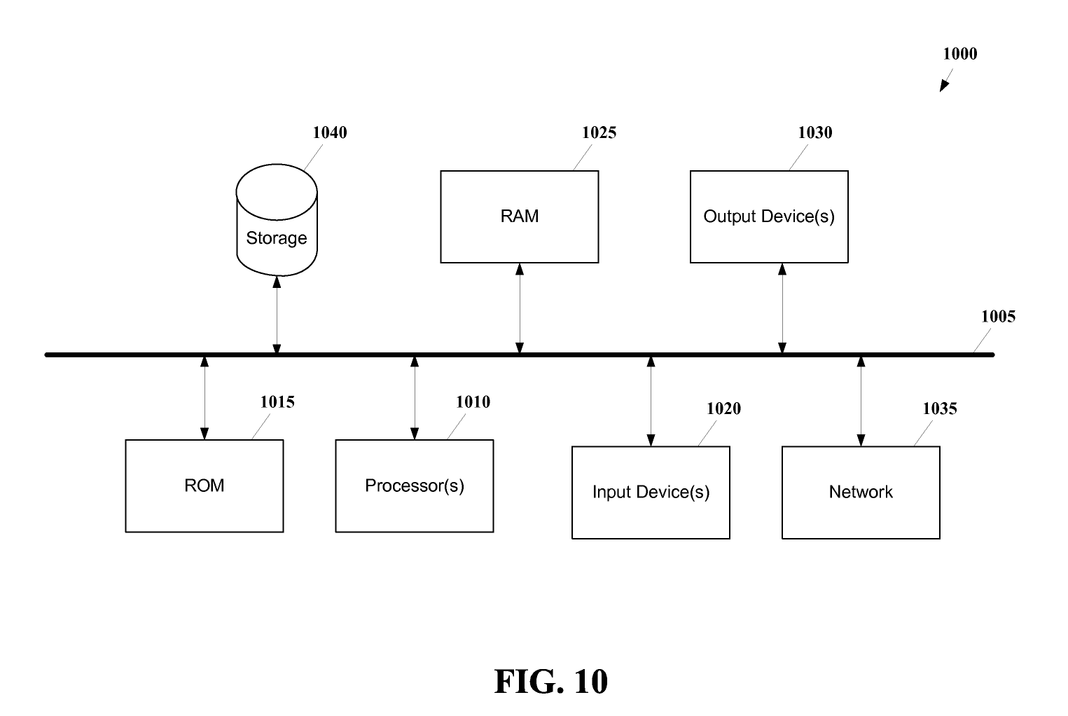

FIG. 10 illustrates an exemplary computer system 1000 that may implement the electronic message service server. The computer system includes various types of computer readable media and interfaces. The system includes a bus 1005, processors 1010, read only memory (ROM) 1015, input device(s) 1020, random access memory 1025), output device(s) 1030, a network component 1035, and a permanent storage device 1040.

The bus 1005 the communicatively connects the internal devices and/or components of the computer system. For instance, the bus 1005 communicatively connects the processor(s) 1010 with the ROM 1015, the RAM 1025, and the permanent storage 1040. The processor(s) 1010 retrieve instructions from the memory units to execute processes of the invention.

The ROM 1015 stores static instructions needed by the processor(s) 1010 and other components of the computer system. The ROM may store the instructions necessary for the processor to execute the web server, web application, or other web services. The permanent storage 1040 is a non-volatile memory that stores instructions and data when the computer system 1000 is on or off. The permanent storage 1040 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The RAM 125 is a volatile read/write memory. The RAM 1025 stores instructions needed by the processor(s) 100 at runtime. The bus 1005 also connects input and output devices 1020 and 1030. The input devices enable the user to communicate information and select commands to the computer system. The input devices 1020 may be a keyboard or a pointing device such as a mouse. The input devices 1020 may also be a touch screen display capable of receiving touch interactions. The output device(s) 1030 display images generated by the computer system. The output devices may include printers or display devices such as monitors.

The bus 1005 also couples the computer system to a network 1035. The computer system may be part of a local area network (LAN), a wide area network (WAN), the Internet, or an Intranet by using a network interface. The web service may be provided to the user through a web client, which receives information transmitted on the network 1035 by the computer system 100.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for” or, in the case of a method claim, the element is recited using the phrase “step for.”

What is claimed is:

1. A method comprising:
receiving an electronic communication from an account associated with a physical address; and
providing a dynamic link to the electronic communication that is accessible to at least one recipient.

2. The method of claim 1, further comprising:
receiving a request to cancel the electronic communication; and
deleting the electronic communication, wherein the dynamic link to the electronic communication is no longer accessible to the at least one recipient.

3. The method of claim 1, further comprising:
receiving a notification that a recipient accessed the electronic communication; and
providing a payment to the recipient in response to the notification.

4. The method of claim 3, further comprising receiving data about the recipient after receiving the notification.

5. The method of claim 4, wherein the data provides information for targeting recipients of an electronic communication.

6. The method of claim 1, further comprising verifying the physical address, wherein verifying the physical address comprises printing a pass code on physical mail.

7. The method of claim 6, further comprising receiving the pass code as user input after the pass code is printed.

8. A system comprising:
a processor configured to:
receive an electronic communication from an account associated with a physical address; and
provide a dynamic link to the electronic communication that is accessible to at least one recipient.

9. The system of claim 8, wherein the processor is further configured to:
receive a request to cancel the electronic communication; and
delete the electronic communication, wherein the dynamic link to the electronic communication is no longer accessible to the at least one recipient.

10. The system of claim 8, wherein the processor is further configured to:
receive a notification that a recipient accessed the electronic communication; and
provide a payment to the recipient in response to the notification.

11. The system of claim 10, further wherein the processor is further configured to receive data about the recipient after receiving the notification.

12. The system of claim 11, wherein the data provides information for targeting recipients of an electronic communication.

13. The system of claim 8, wherein the processor is further configured to verify the physical address, wherein verifying the physical address comprises printing a pass code on physical mail.

14. The system of claim 13, wherein the processor is further configured to receive the pass code as user input after the pass code is printed
